(19) United States
(12) Patent Application Publication
(10) Pub. No.: US 2003/0021869 A1
(43) Pub. Date: Jan. 30, 2003

(54) ENCAPULATED ALCOHOLIC BEVERAGE

(76) Inventors: JAMES PAUL WEST, GAINESVILLE, FL (US); WILLIAM III TOREKI, GAINESVILLE, FL (US)

Correspondence Address: VAN DYKE & ASSOCIATES, P.A., 7200 LAKE ELLENOR DRIVE, SUITE 252, ORLANDO, FL, 32809, US

(21) Appl. No.: 09/430,906

(22) Filed: Nov. 1, 1999

(51) Int. Cl. A23L 1/00

(52) U.S. Cl. 426/89

(57) ABSTRACT

This invention provides ingestible, chewable, or aqueous soluble non-toxic capsules containing sufficient quantities of ethanol compositions to facilitate transport of recreationally relevant quantities of such ethanol compositions for ingestion and appreciation of the physiological effects of such ingestion.

### FIELD OF THE INVENTION

This invention pertains to the field of ingestible recreational beverages, and in particular, to recreational beverages with a significant alcohol content, contained within a non-toxic, ingestible, chewable or water soluble capsule.

### BACKGROUND OF THE INVENTION

There is a well established base of knowledge relating to the manufacture of encapsulated liquid and powder formulations. For example, U.S. Pat. No. 3,653,934 provides a method for making a gastro-resistant gelatin capsule. U.S. Pat. No. 3,656,997 provides a method for making coated gelatin capsules. U.S. Pat. No. 3,959,540 provides gelatin capsules resistant to gastric juice dissolution. U.S. Pat. No. 3,779,942 provides capsules and processes for manufacture thereof which provide an improved vapor barrier. For their teachings of capsule formation, these references are hereby included by reference. However, no disclosures have been found where such encapsulation methodologies or devices were implemented for provision of recreational encapsulated alcoholic beverages.

In the field of human medicine, there are instances of medicinal compositions formulated in an excipient, such as a small quantity of ethanol, encapsulated within a capsule made from gelatin or another non-toxic, digestible or non-digestible material. However, in such formulations, the total content of ethanol is intentionally maintained at an essentially nominal level, in order to avoid alcohol induced effects, such as inebriation or mood alteration. For example, in U.S. Pat. No. 4,888,239, there was provided an ethanol fill formulation for softgels and the like wherein a small quantity of ethanol (milligram quantities) was provided as a solvent for other ingredients, and the entire liquid composition was encapsulated in a gelatin capsule. It should be noted that in the referenced patent, the inventor appeared to have been under the misapprehension that in order for compositions containing greater than ten percent (10%) ethanol content to be successfully encapsulated in a gelatin capsule, such additional ingredients as partial glycerides must be included in the encapsulated composition. In one interesting variation on this theme, see U.S. Pat. No. 4,834,981, a “vaccine” was described for preventing metabolism of ingested methanol, through delivery of small quantities of encapsulated ethanol. The selective metabolism of ethanol which is gradually released from a carrier means was intended to limit the level of methanol metabolized after swallowing the vaccine. However, as with the other medicinal encapsulated compositions known in the art, the composition contemplated by this patent is expressly designed to avoid induction of any ethanol-induced intoxicating effects. Accordingly, the referenced patent teaches away from the present invention in which a sufficient quantity of ethanol is delivered in an encapsulated form to induce a recreational effect similar to ingesting a social alcoholic beverage.

In the field of human food consumption and confections, there have been instances of liqueur-filled chocolates and the like. However, as with the known medicinal capsules discussed above, the total alcohol content of such confections has historically been of such a low total amount that inebriation effects of the contained alcohol are essentially negligible.

It is known to generate a consumable item colloquially known as a “Jell-O-Shot”, which is essentially a gelatin-based desert composition, mixed with a shot (approximately 1-2 ounces) of an alcoholic beverage, and then allowed to cool and gel. Consumed in this form, alcohol can be ingested for recreational purposes as a novelty activity at an adult party and the like. However, in Jell-O-Shots, the alcohol is dispersed within the gelatin composition, essentially uniformly, and there is no encapsulating shell. As a result, such alcohol compositions are not easily transportable, have no mechanical strength, and are subject to “melting” or liquefaction if retained at ambient or slightly above ambient temperatures.

Of course, alcoholic beverages are commercially available in small bottles or other containers made of glass, plastic or the like. However, such containers are not ingestible, chewable, or readily dissolvable when contacted with a liquid such as an aqueous beverage.

Accordingly, there remains a need for a readily transportable alcoholic composition for recreational ingestion of alcohol wherein a sufficient quantity of alcohol is held within an ingestible, chewable or aqueous soluble capsule to permit one or a plurality of such capsules to be ingested, chewed or dissolved to provide the recreational physiological effects for which alcohol is generally consumed as a recreational activity.

### SUMMARY OF THE INVENTION

This invention provides ingestible, chewable, or aqueous soluble non-toxic capsules containing sufficient quantities of ethanol to facilitate transport, storage, delivery and consumption of recreational quantities of such alcohol compositions.

Accordingly, it is one object of this invention to provide an easily transportable recreational quantity of ethanol in an ingestible container, such as a capsule.

Another object of this invention is to provide an easily transportable recreational quantity of ethanol in a chewable container, such as a capsule.

Another object of this invention is to provide an easily transportable recreational quantity of ethanol in an aqueous soluble container, such as a capsule.

Other objects and benefits of this invention will be apparent from a review of the complete disclosure and the claims appended hereto.

### DETAILED DESCRIPTION OF THE PREFERRED EMBODIMENTS

As used in this disclosure and the claims appended hereto, the terms “recreational quantities” and “recreationally relevant quantities” of an alcoholic composition refers to any amount of an ethanol containing composition which, alone or in combination with repeated doses of the same amount of ethanol, produces a noticeable recreational physiological effect on the consumer of such a quantity of ethanol. Thus, consumption of between about one and about ten capsules according to this invention are considered to come within the scope of this definition of recreationally relevant quantities of ethanol containing capsules.

In a first embodiment of this invention, a small, soft, thick-walled, edible sphere, ellipse, elongated tube, or similarly shaped capsule composed of gelatin, alginate, xanthan gum, guar gum, chitin, chitosin, gellan gum, agar, carrageenan, albumin, starch, carboxymethylcellulose (CMC), mixtures thereof, similar polymers, or the like is provided containing within an enclosed cavity approximately 0.5 to 1.5 ounces of ethanol. Alginate is one preferred encapsulating material because it is highly water soluble, but is insoluble in ethanol and ethanol/water mixtures. It is also inexpensive, and is acceptable as a foodstuff. However, gelatin has the advantage as an encapsulating material in that it is heat-moldable. The ethanol contained within the cavity formed by the gelatin, alginate or like material may be pure, substantially pure, or relatively dilute ethanol, for addition to and dissolution in an aqueous solution, such as a fruit juice, soft drink (e.g. any commercially available mixer, soda, or the like), or in water. Alternatively, the alcohol may be mixed with water, syrup, gel, flavoring or the like, such that the capsule may be directly dissolved in a person's mouth, chewed or swallowed for dissolution inside the digestive tract, or dissolved in a consumable aqueous solution. The alcohol content may be between about 5% and about 95% ethanol, and preferably is in the range between about 25% to about 70%, and most preferably, in the range between about 40% and about 50% ethanol. The total internal volume of the capsule is preferably between about 5 milliliters to about 50 milliliters, and most preferably between about 10 milliliters and about 30 milliliters.

It will be appreciated that any encapsulating, non-toxic material may be used according to this invention to deliver the ethanol composition for recreational purposes. However, it is preferred for the encapsulating material to be digestible, in instances where the capsule is designed to be ingested. In such instances, the encapsulating material should be comprised of gelatin or alginate or like digestible material, and the capsule may be designed for breakage in the consumer's mouth, or for easy swallowing. To that end, it may be, in addition, desirable for the capsule to be coated with a sugar coating or the like, such that as the capsule contacts the salivary juices in the mouth, additional saliva is produced, the capsule has a pleasant taste, and as the sugar dissolves, it ensures ease of swallowing. For such applications, it is furthermore desirable for the capsule to have a geometry, such as an elliptical or elongated geometry, such that the diameter of the capsule is sufficiently small to permit easy passage into the digestive tract.

In a further embodiment, where it is intended for the capsule not to be swallowed, such as, for example, where the encapsulating material is non-digestible, or where the alcohol content is particularly high, it is preferred for the capsule to have a shape that would prevent swallowing, but which at the same time would ensure that choking on the capsule is extremely unlikely or impossible, such as, for example, where the capsule is substantially too large to swallow, in which case the capsule has to be broken in the mouth, for example by chewing, or dissolved in an aqueous beverage, which is then swallowed in liquid form. In another alternative embodiment, where the capsule is intended not for ingestion, the capsule may be in the form of a life-saver buoy, i.e. being of a contiguous tubular shape in the form of a circle, with an internal canal or cavity, such that upon the unlikely event of lodgment in a consumer's throat, there is sufficient space for air to pass through the canal to prevent asphyxiation.

It will be appreciated from this disclosure that it is preferred for the encapsulating material to be capable of sustaining various concentrations of ethanol within the internal compartment, without dissolution into the ethanol. It is also preferred for the encapsulating material to be of sufficient rigidity to sustain packaging and storage for from several minutes to several weeks. This goal is achievable using gelatin, if sufficient concentrations of gelatin are incorporated into the encapsulating material, or where the molecules constituting the gelatin capsule are cross-linked with a cross-linking agent, such as but not limited to glutaraldehyde. Methods of achieving this goal are known in the art and therefore, are not discussed in detail here. Alternative encapsulating materials which meet these criteria include waxes, synthetics and the like, which are non-toxic and stable in the presence of ethanol compositions. For such compositions, chewing and ejecting the capsule may be preferred.

In a further embodiment of this invention, the capsule comprises a pH sensitive component such that known dissolution characteristics may be imparted to the encapsulant. Thus, for example, encapsulating compositions may be prepared according to methods known in the art such that upon exposure of the capsule to a specific elevated or decreased pH, the encapsulating material rapidly dissolves, hardens, becomes permeable or the like. In one particular application, for example, the encapsulant is designed to dissolve in a solution of reduced pH. Thus, contact of the capsule of this invention with a tomato juice cocktail, or a drink containing lemon or lime juice or the like would result in rapid dissolution of the capsule, and release of the contained alcohol composition into the drink, to form an alcoholic beverage. In this manner, specific dissolution characteristics within the digestive tract may also be imparted to the capsule.

In view of the present disclosure, those skilled in the art will appreciate that a number of specific applications may benefit from inclusion of recreationally relevant quantities of ethanol in encapsulated forms of various sizes, shapes, and physico-chemical characteristics. Thus, for example, in one specific application, a capsule having the appearance of an olive, may include a sufficient quantity of ethanol such that deposition of the “olive” into a beverage will result in dissolution at a certain time after such deposition to provide a “refresher” or “kicker” to the beverage. In another specific embodiment of the capsule of this invention, a wax-based capsule containing between about 5 milliliters to about 50 milliliters of optionally flavored ethanol. The capsule according to this invention includes capsules wherein the alcoholic beverage is a wine, spirit, mixed drink, brandy, flavored alcohol, tequila, vermouth, gin, vodka, or a mixture thereof or equivalents thereof.

The ethanol may be 50 proof, or any other desirable concentration may be used. The ethanol ball is chewed by a consumer, and the waxy encapsulant material is discarded, chewed like gum, or swallowed for elimination in the natural course of events. In yet a further embodiment of this invention, the alcoholic beverage may be any of a number of different wines. In this manner, aside from enjoying the physiological effects of alcohol consumption, the invention provides a novel and enjoyable means for tasting of a number of different wines. In this manner, a wine-tasting kit may also be included within the scope of this invention in the form of a container bearing a plurality of encapsulated wines of different origins and qualities. Similar kits may be envisioned for any other form of recreational alcoholic beverage. Based on the present disclosure, further uses of the alcoholic beverage containing capsules of this invention will be suggested to those skilled in the art, such as, for example, use of the alcoholic-beverage containing capsules of this invention in cooking or baking recipes for edible goods which call for inclusion of quantities of alcohol, with or without flavoring or food coloring.

Having generally described this invention, including its best mode, the following specific examples are provided to provide detailed written disclosure of the invention. However, the scope of this invention should not be construed as being limited by the specifics of these examples. Rather, the scope of this invention should be determined through reference to the complete disclosure and the claims appended hereto. It should further be noted that while the following examples provide descriptions of specific compositions of matter, produced according to disclosed small-scale processes, those skilled in the art will appreciated that highly automated and mechanized, large-scale methods for producing the encapsulated products of this invention come within the scope of this invention. Methodology known, for example, by pharmaceutical and paint-ball manufacturers is to be expected to be applicable to producing the product of this invention when modified according the principles set forth herein.

### EXAMPLE 1

This example demonstrates the manufacture of a sealed gelatin capsule containing rum which has an ethanol content of approximately 75%. Commercially-available gelatin capsules in the form of “paint-balls” were emptied of their contents by pricking opposite ends with a needle. The paint-like filling material was removed through the resulting holes. The residual filling material was rinsed out with acetone, and then with ethanol. The clean, empty shells were dried in air at room temperature and low humidity.

Some of these cleaned capsules were then chopped and mixed with an equal volume of distilled water. This mixture was heated over a hot water bath with stirring until a viscous gelatin solution was obtained. One drop of this warm solution was applied to cover the aforementioned hole in the bottom of several dried gelatin capsules. The shells were then allowed to dry. This resulted in the sealing of one hole in each capsule, leaving the upper hole open. A syringe was filled with 151 proof (75% ethanol) rum. An 18 gauge needle was affixed to the syringe, and each capsule was filled to within 2 mm of the hole with rum. A drop of warm gelatin solution was then used to cover the hole. This resulted in a sealed gelatin capsule containing 151 proof rum.

### EXAMPLE 2

This example illustrates the manufacture of imitation “olives” which contain a vermouth-flavored alcohol solution. The process described in Example 1 was used. The filling solution consisted of a mixture of ethanol, water, and vermouth with an alcohol content of approximately 60%. Green food-coloring was added in order to give the appropriate olive color. The finished capsules were stored in a solution identical to the filling material. The capsules tended to increase in size somewhat during this storage. The imitation olives gradually swelled and softened when placed into beverages such as martinis or tonic water, and were easily penetrated with a cocktail straw, allowing consumption of the contents.

### EXAMPLE 3

This example illustrates the penetration of a polymer/wax-based capsule containing wine. A commercially-available laboratory sealing film (Parafilm-M) was used to prepare the capsules in this example. This film has the ability to be stretched quite substantially in order to give a very thin membrane. A section of Parafiilm-M was folded onto itself to form a rectangle which was then heat-sealed on three sides. A 20 cc sample of wine was introduced into the resulting bag via pipet. The open end was twisted shut, and the wine was “milked” towards the bottom of the capsule using finger pressure. This caused an embolism-like, spherical bulge in the lower part of the Parafilm bag. This bulge was then pinched-off from the upper part of the bag and heat-sealed using heated forceps. The resulting capsule could be put into the mouth and chewed to expel the contents, thus allowing the wine to be consumed. The waxy membrane could be swallowed, expelled, or chewed like gum if desired.

### EXAMPLE 4

This example follows the same process as Example 3; however, in this case the flexible membrane was filled with 80 proof tequila, plus a pinch of table salt, and a small slice of lemon without the rind.

### EXAMPLE 5

A glass mold was produced which consisted of a flat base plate and a conical top. A small hole was left open in the conical top. An aqueous solution of gellan gum was placed onto the base plate, and the conical top was then set in place. Additional gellan solution was then added via the hole in the conical top. The gellan solution was viscous enough that a thick film of this solution remained clinging to the sides of the glass mold. A solution consisting of 100 proof vodka and a small amount of calcium chloride was added to the mold using a syringe. This caused gelling and hardening of the gellan gum solution to form a rubbery membrane. Care was taken to avoid contact of the alcoholic calcium filling solution with the portion of the gellan solution clinging to the mold near the small orifice at the top of the glass cone. Additional gellan solution was introduced in this area so that the hole was covered. The mold was then inverted in order to finish shell formation. The capsule was removed from the shell and cured by immersion in a solution identical to the filling material.

Having generally described various embodiments of this invention, none of which are meant to be limiting, those skilled in the art are referred to the attached claims and equivalents thereof suggested by the present disclosure for an understanding of the scope of this invention.

What is claimed is:

1. An ingestible, chewable, or aqueous soluble non-toxic capsule containing a sufficient quantity of an ethanol composition to facilitate transport, storage, delivery and consumption of recreationally relevant quantities of such alcohol composition.

2. The capsule according to claim 1 comprising an easily transportable recreationally relevant quantity of ethanol in an ingestible container.

3. The capsule according to claim 1 comprising an easily transportable recreationally relevant quantity of ethanol in a chewable container.

4. The capsule according to claim 1 comprising an easily transportable recreationally relevant quantity of ethanol wherein said capsule is soluble, swells, softens, bursts, becomes permeable, or is easily ruptured when contacted with aqueous solutions.

5. The capsule according to claim 1 in the shape of spheres, ellipses, elongated tubes, or similarly shaped capsule composed of gelatin, alginate, xanthan gum, guar gum, chitin, chitosin, gellan gum, agar, carrageenan, albumin, starch, carboxymethylcellulose (CMC), or mixtures thereof.

6. The capsule according to claim 5 wherein said capsule contains within an enclosed, sealed cavity, approximately 0.5 to 1.5 ounces of an ethanol composition.

7. The capsule according to claim 6 wherein said ethanol contained within the cavity of said capsule is pure, substantially pure, or diluted ethanol, for addition to and dissolution in an aqueous solution, such as a fruit juice, soft drink or in water, or wherein the alcohol is mixed with water, syrup, gel, flavoring and the like, such that the capsule may be directly dissolved in a person's mouth, chewed or swallowed for dissolution inside the digestive tract.

8. The capsule according to claim 6 wherein said alcohol is between about 5% and about 95% ethanol.

9. The capsule according to claim 6 wherein said alcohol is between about 25% to about 70% ethanol.

10. The capsule according to claim 6 wherein said alcohol is between about 40% and about 50% ethanol or about 50% and 70% ethanol.

11. The capsule according to claim 1 wherein the total internal volume of the capsule is between about 5 milliliters to about 50 milliliters.

12. The capsule according to claim 1 wherein the total internal volume of the capsule is between about 10 milliliters and about 30 milliliters.

13. The capsule according to claim 1 wherein said capsule comprises a non-toxic material as the encapsulant to deliver the ethanol composition for recreational purposes.

14. The capsule according to claim 13 wherein the encapsulating material is digestible.

15. The capsule according to claim 14 designed for breakage, crushing, or dissolving in the consumer's mouth and optionally for subsequent expultion, or for easy swallowing.

16. The capsule according to claim 15 wherein said capsule is coated with a sugar coating, a flavored coating, a water impermeable coating, a wax coating, a coating which prevents evaporation, or a coating which combines these coatings.

17. The capsule according to claim 14 having a geometry such that the diameter of the capsule is sufficiently small to permit easy passage into the digestive tract.

18. The capsule according to claim 13 wherein the encapsulating material is non-digestible, or where the alcohol content is particularly high, having a shape that prevents swallowing, but which at the same time ensures that choking on the capsule is extremely unlikely or impossible.

19. The capsule according to claim 18 wherein the capsule is substantially too large to swallow, in which case the capsule has to be broken in the mouth, for example by chewing, or dissolved in an aqueous beverage, which is then swallowed in liquid form.

20. The capsule according to claim 18 in the form of a life-saver buoy, i.e. being of a contiguous tubular shape in the form of a circle, with an internal canal or cavity, such that upon the unlikely event of lodgment in a consumer's throat, there is sufficient space for air to pass through the canal to prevent asphyxiation.

21. The capsule according to claim 1 wherein the encapsulating material is capable of sustaining various concentrations of ethanol within the internal compartment, without dissolution into the ethanol.

22. The capsule according to claim 21 wherein said encapsulating material is sufficient to sustain packaging and storage for from several minutes to several months.

23. The capsule according to claim 22 comprising sufficient concentrations of gelatin included in the encapsulating material to form said encapsulating material, or wherein the molecules constituting the gelatin capsule are cross-linked with a cross-linking agent.

24. The capsule according to claim 23 wherein said gelatin is cross-linked with glutaraldehyde.

25. The capsule according to claim 1 comprising a pH sensitive component such that known, pH-dependent dissolution characteristics are imparted to the encapsulant.

26. The capsule according to claim 25 wherein, upon exposure of the capsule to a specific elevated or decreased pH, the encapsulating material rapidly dissolves, softens, swells, ruptures, hardens, or becomes permeable.

27. The capsule according to claim 26 wherein the encapsulant dissolves in a solution of reduced or elevated pH.

28. The capsule according to claim 1 having the appearance of a garnish.

29. The capsule according to claim 29 having the appearance of an olive.

30. The capsule according to claim 28 comprising a sufficient quantity of ethanol such that deposition into a beverage results in dissolution, swelling, rupture, ease of breakage or permeability at a certain time after such deposition to provide a “refresher” or “kicker” of released ethanol to the beverage.

31. The capsule according to claim 1 comprising a wax-based capsule containing between about 5 and 50 cc of optionally flavored ethanol of pure or substantially pure or diluted ethanol.

32. The capsule according to claim 31 wherein the capsule is chewed by a consumer, and the waxy encapsulant material is discarded, chewed like gum, or swallowed for elimination in the natural course of events.

33. The capsule according to claim 1 wherein the alcoholic beverage is a wine, spirit, mixed drink, brandy, flavored alcohol, tequila, vermouth, gin, vodka, or a mixture thereof.

34. A wine-tasting kit comprising a container bearing a plurality of encapsulated wines of different origins and qualities.

35. A kit comprising a series of ingestible or chewable capsules containing sufficient quantities of different alcoholic beverages such that ingestion or chewing of each said capsule releases a recreationally relevant quantity of ethanol into the digestive tract of a consumer as to permit the recreational physiological effects of ethanol consumption to be appreciated by the consumer upon consumption of one to several of said capsules.

36. A method of delivering recreationally relevant quantities of ethanol to consumers of ethanol which comprises encapsulating said recreationally relevant quantities of ethanol in non-toxic ingestible, chewable or aqueous soluble capsules.

37. A method of delivering alcohol in a recipe for a consumable good which comprises including in said recipe one or more capsules containing recreationally relevant quantities of an ethanol composition and releasing the ethanol composition into said consumable good under determined conditions.
